(19) United States
(12) Patent Application Publication
(10) Pub. No.: US 2005/0139666 A1
(43) Pub. Date: Jun. 30, 2005

(54) Verifiable voting input system

(76) Inventor: Henwell Chou, West Hartford, CT (US)

Correspondence Address: MCCORMICK, PAULDING & HUBER LLP, CITY PLACE II, 185 ASYLUM STREET, HARTFORD, CT, 06103, US

(21) Appl. No.: 10/909,898

(22) Filed: Aug. 2, 2004

Related U.S. Application Data
(60) Provisional application No. 60/532,540, filed on Dec. 24, 2003.

(51) Int. Cl. G06F 17/60

(52) U.S. Cl. 235/386

(57) ABSTRACT

A voting system including a plurality of ballots formed of digital paper each having a ballot form printed on a writing surface thereof and a unique identifier associated with each ballot. Data representing the ballot form and the location thereof relative to the writing surface is stored in the computer. A digital pen connectable to the computer is compatible with the digital paper for recording pen strokes made by the digital pen and the location of the pen strokes relative to the writing surface. The digital pen includes an ink dispensing tip for marking the writing surface according to the pen strokes. The computer is connectable to the digital pen for retrieving and storing the data representing the pen strokes for each ballot. Upon completion of a ballot, the computer compares the data representing the pen strokes with the ballot form data and determines the voter selections for the ballot.

### CROSS-REFERENCE TO RELATED APPLICATION

This application claims the benefit of U.S. Provisional Application No. 60/532,540, filed on Dec. 24, 2003, the disclosure of which is herein incorporated by reference in its entirety.

### FIELD OF THE INVENTION

The present invention is generally directed to an apparatus for an integrated paper and electronic document verification process and in particular to a verifiable voting input system.

### BACKGROUND OF THE INVENTION

Recently, many devices have been proposed for casting ballots electronically. For example, U.S. patent application Publication No. US 2003/0173404 A1 published Sep. 18, 2003 discloses a method for reading ballots including reading/imaging each ballot transported on a transport path. Each ballot is read/imaged for orientation indicia, jurisdiction information, and voting selections. The disclosed method requires optically scanning each ballot following the completion of the ballot by a voter.

A voter feedback and receipt system is disclosed in U.S. patent application Publication No. US 2002/0161628 A1 published Oct. 31, 2002. The system includes voter verification of an interpretation of a voter's ballot by a ballot counting device, electronic recording of the verified ballot, and providing a receipt of the verified ballot and votes cast. This system also requires optical scanning of each ballot following completion of the ballot by a voter.

U.S. patent application Publication No. US 2003/0006282 A1 published Jan. 9, 2003 discloses a system and method for electronic voting wherein a voter makes voting selections on a touch screen display. After the voting selections are complete, a voter verifiable paper ballot is printed and an electronic ballot is saved on the system. If the voter is not satisfied with the voting selections reflected on the paper ballot, the paper ballot and the electronic ballot may be discarded and the voter provided a new ballot. This system does not provide a paper ballot that can be utilized in a recount.

Notable disadvantages of the above-identified prior art voting systems are that either an original paper ballot is not used such that there is no original record of the ballots as cast that can be used for a recount, or the system requires optical scanning of each paper ballot and interpreting of the scanned data. The process of scanning each paper ballot cast is a time consuming and expensive step that also inherently includes the possibility of scanning errors which can lead to voter frustration or distrust of the system, especially in close elections.

International patent publication number WO/03/042931 of Lee et al. (hereinafter referred to as “Lee”) discloses an apparatus and method for recording and counting votes. The Lee apparatus includes a writing implement having a writing tip, means for electronically sensing the position of the writing tip relative to a datum position, and means for electronically interpreting the position of the writing tip sensed by the sensing means so as to provide an electronic indication of a mark applied to a voting paper with the writing implement during use.

The Lee apparatus and method provides both a paper ballot and an electronic image thereof; however, Lee does not include means for identifying each of the paper ballots. Nothing is provided to identify one paper ballot from another. The apparatus includes means for including a voter identification number with the electronic data recorded from each paper ballot. However, nothing is provided to correlate the original paper ballot with the electronic data received from the digital pen that is recorded from each ballot. Thus, in a recount of the original ballots, there is no way to correlate the recounted totals with the electronically stored images of the ballots and tabulated results.

Based on the foregoing, it is the general object of the present invention to provide a verifiable voting system that improves upon, or overcomes the problems and drawbacks associated with prior art voting systems.

### SUMMARY OF THE INVENTION

The present invention provides a computer implemented voting system including a plurality of paper ballots each formed from a sheet of digital paper having a writing surface. A ballot form is printed on the writing surface for completion by a voter during a voting process. Each paper ballot also includes a unique identifier formed on the writing surface. Ballot form data representing the ballot form and the location thereof relative to the writing surface of the digital paper is stored in the memory of the computer.

A digital pen connectable to the computer is also provided. The digital pen is compatible with the digital paper for recording pen strokes made by the digital pen and the location of the pen strokes relative to the writing surface of the digital paper. The digital pen also includes an ink dispensing tip for marking the writing surface of the paper according to the pen strokes.

In a preferred embodiment, the unique identifier includes at least one pattern corresponding to an identifiable cell of a master sheet of the digital paper such that the unique identifier is recordable via the digital pen. The digital pen is for recording data representing the unique identifier and the pen strokes formed on each of the paper ballots used in a voting process. The computer is connectable to the digital pen for retrieving from the digital pen the data representing the unique identifier and the pen strokes formed on each of the paper ballots and for storing the unique identifier and the corresponding pen strokes data for each paper ballot.

Following the completion or acceptance of a paper ballot, the computer processes the data representing the pen strokes including comparing the pen strokes data with the corresponding ballot form data and determining the voter selections for the paper ballot. The voter selections for each paper ballot are then stored along with the pen strokes corresponding to the unique identifier for each ballot. The voter selections are tabulated for determining the results of a voting process.

Thus, the present invention voting system provides identifiable electronic data corresponding to each of a plurality of paper ballots for processing the results of a voting process via the computer and the paper ballots for verification of the results generated by the computer. Additionally, the unique identifier coupled with the voter selections for each ballot can be used for analysis regarding the voting process and the results thereof. For example, the paper ballots delivered to a certain voting location or precinct can be reviewed and compared with the results of other locations.

In a preferred embodiment the present invention utilizes an Anoto®-compliant digital pen or equivalent and Anoto®-compliant digital paper or equivalent that is compatible for use with the digital pen. (Anoto is a registered trademark of Anoto GroupAB of Sweden). The digital pen is connected either wirelessly or wired to a Windows based Personal Computer (PC) or UNIX based workstation or other computer system. Alternatively, a docking station can be used for connecting the digital pen to the computer.

As used herein, the terms digital pen and digital paper are used to describe known devices that cooperate to provide electronic data representative of pen strokes and the location thereof relative to the digital paper such that the pen strokes are reproducible by a computer in communication with at least one of the digital pen and digital paper.

Accordingly, one object of the present invention is to provide a voting system that simultaneously generates both an electronic ballot and a paper and ink ballot.

Another object of the present invention is to provide a verifiable voting input system and method that is verifiable through the storage (archiving) of original paper ballots.

Another object of the present invention is to provide a verifiable voting input system and method that can be used to validate the results of a voting process including verifying voting results corresponding to each and every one of a plurality of paper ballots cast.

Another object of the present invention is to provide a verifiable voting input system and method wherein an electronic copy of each original paper ballot cast by a voter is stored in the system for future retrieval, review and and/or reproduction.

Other advantages and objects of the present invention that will be apparent or obvious from the detailed description or illustrations contained herein are within the scope of the present invention.

### BRIEF DESCRIPTION OF THE DRAWINGS

FIG. 1 is a schematic view of one embodiment of a voting system according to the present invention.

FIG. 2A illustrates a paper ballot according to the present invention.

FIG. 2B is an enlarged view of a portion of a typical dot pattern reproduced from a sheet of Anoto® digital paper.

FIG. 3 is a perspective view of a digital pen and cap for use in the voting system of the present invention.

FIG. 4 shows a voting screen according to the present invention including an image of a blank paper ballot on the left side of a split screen and an image of a verification screen on the right side.

FIG. 5 is an illustration of the voting screen of FIG. 3 as filled in according to a vote cast by a voter.

FIG. 6 is an illustration of the voting screen of FIG. 3 displaying an image of a paper ballot on the left screen that has been incorrectly filled in by a voter and a corresponding verification screen on the right side that includes a notification of the voting error.

FIG. 7 is a diagram of an overview of the back end process of a voting system according to the present invention.

FIG. 8 is a diagram of one embodiment of a grid as used with a master sheet of digital paper for establishing unique identifiers for a plurality of paper ballots according to the present invention.

FIG. 9 is a diagram showing a series of four ordered master sheets of digital paper as used to establish unique identifiers for a plurality of paper ballots according to the present invention.

FIG. 10 is an example of a blank sheet of digital paper having a unique identifier according to the present invention.

FIGS. 11a and 11b illustrate the unique identifier of the digital sheet 26 of FIG. 10 shown marked for registering a paper ballot in accordance with the present invention.

FIG. 12 is an illustration of the paper ballot of FIG. 2A having a unique identifier formed on the writing surface thereof.

### DETAILED DESCRIPTION OF THE PREFERRED EMBODIMENTS

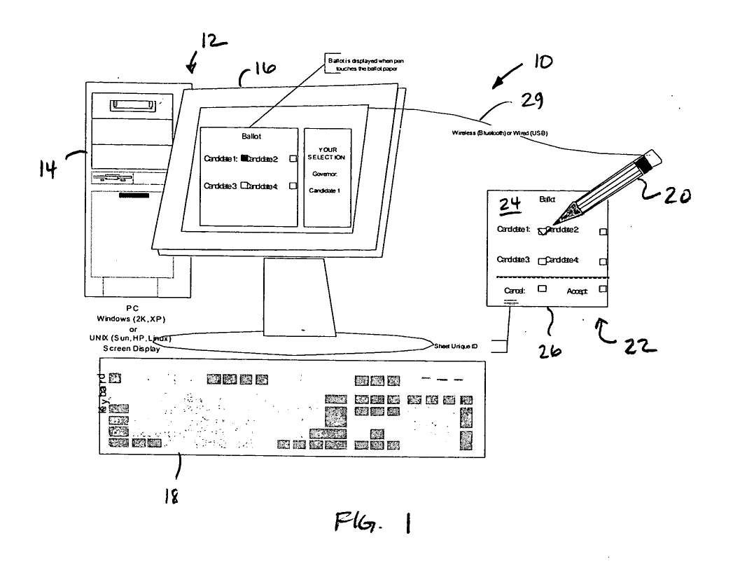

As shown in FIG. 1, a voting system in accordance with the present invention is generally designated by the reference number 10. The voting system 10 comprises a computer 12. The computer 12 includes a processor 14, a monitor 16 and a keyboard 18. A digital pen 20 is connected to the processor 14 via a wire 29. In other embodiments the digital pen 20 can be wireless or dockable with the computer 12 using a docking station (not shown). The voting system 10 also comprises a paper ballot 22 that includes a writing surface 24 formed of digital paper 26.

The computer 12 is preferably a personal computer (PC) employing Windows Operating System (98, NT, Windows 2000, XP or any future Windows OS) or a Unix Workstation that supports the digital pen 20 and the digital paper 26. The computer 12 can include a hard drive either installed locally or accessible remotely from a server or the Internet. The monitor 16 displays the computer output to a user and may include a touch screen for inputting information to the processor 14. The computer 12 may also include other input devices such as a mouse, keypad, or joystick. Appropriate software is also provided for operating the digital pen 20, digital paper 26, and the voting system 10 of the present invention.

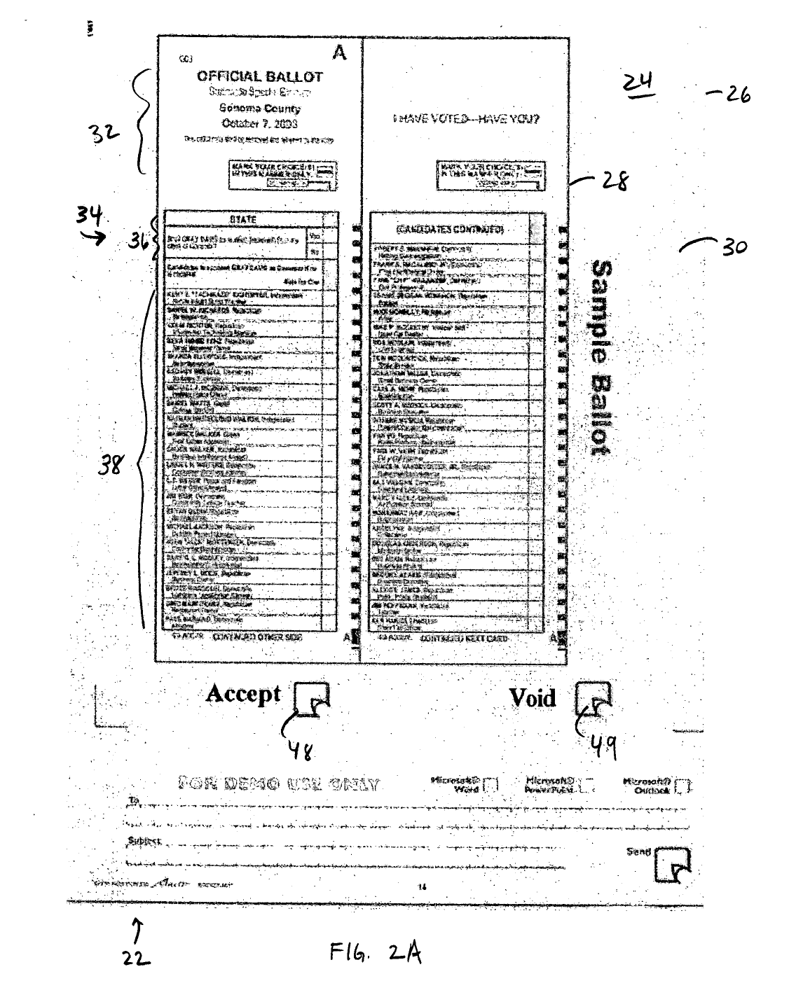

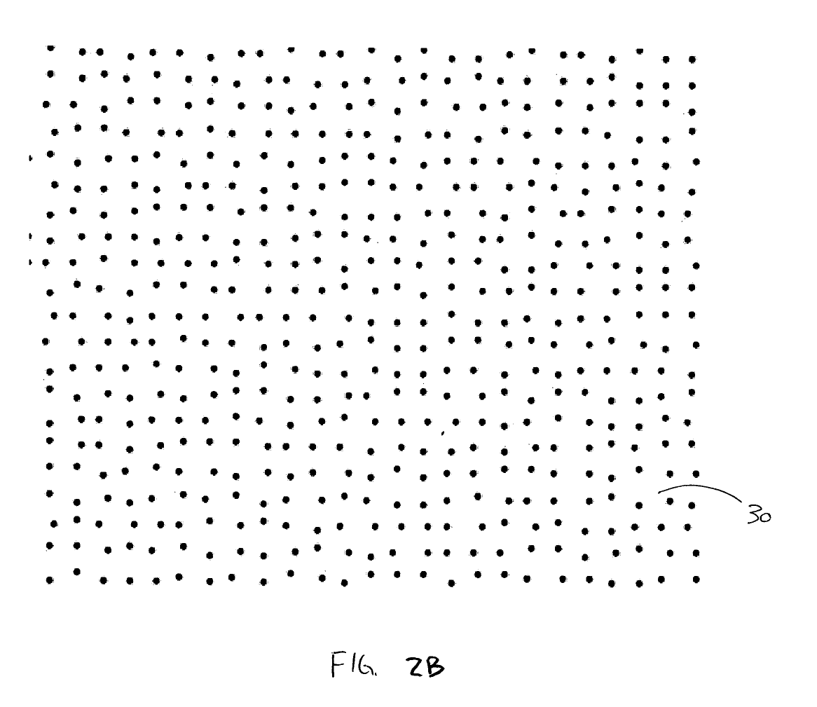

Referring to FIGS. 2 and 3, the paper ballot 22 according to the present invention includes a ballot form 28 printed on the writing surface 24 that is formed of the digital paper 26. In a preferred embodiment, the voting system 10 utilizes Anoto® digital paper which is a product of Anoto AB of Sweden. However, other types of digital paper can be substituted without departing from the scope of the present invention.

The digital paper 26 includes a plurality of small or minute dots disposed in a pre-defined dot pattern 30 throughout the writing surface 24 of the digital paper. The dot pattern 30 defines coordinates throughout the entire writing surface 24 which are pre-stored in a memory of the computer 12. FIG. 2B shows an enlarged view of a typical portion of a dot pattern 30 reproduced from a sheet of Anoto® digital paper. When a user applies direct pressure to the digital pen 20 against the digital paper 26, the digital pen marks the writing surface 24 with ink as does an ordinary ink pen and also senses and thereby records the dot pattern 30 of the digital paper 26 at the location of the pen strokes. Accordingly, data representing both the pen strokes and the exact location of the pen strokes relative to the writing surface 24 are recorded and stored in the digital pen 20.

In the preferred embodiment, a tiny camera in the digital pen 20 registers the digital pen's movement across the dot pattern 30 of the writing surface 24 and stores the pen stroke as series of map coordinates. The map coordinates correspond to exact locations of the writing surface 24 that are pre-stored in a memory of the computer 12 and associated with a serial number or identifier corresponding to a sheet of the digital paper 26. As the digital pen 20 moves with a writing pressure across the digital paper 26, the digital pen senses the dot patterns 30 and thereby records the direction and coordinates of the pen strokes. The pen strokes recorded by and stored in the digital pen 20 can be transmitted to the computer 12 in real time if the digital pen is coupled to the computer while creating the pen strokes. In the FIG. 1 embodiment, the digital pen 20 is coupled to the computer 12 via a cable 29 such that pen strokes created by the digital pen 20 and the dot pattern 30 providing the coordinates of the pen strokes relative to the digital paper 26 are transmitted to the computer 12 in real time. Alternatively, the digital pen 20 can be configured for wireless communication with the computer 12 in real time. A wireless digital pen 20 is shown in FIG. 3.

In other embodiments of the voting system 10, a digital pen 20 is configured to communicate with the computer 12 via a docking device (not shown) following the completion of a series of pen strokes. For example, upon completion of the paper ballot 22, or a plurality of paper ballots, a digital pen 20 can be placed in a conventional docking device that is connected to the computer 12 and configured to transmit data corresponding to the stored pen strokes and the corresponding map coordinates on the digital paper 26 to the computer 12.

Referring again to FIG. 2A, the voting system 10 provides a paper ballot 22 that includes a writing surface 24 formed of digital paper 26 as described above. The paper ballot 22 allows a voter to cast his/her vote by marking or filling out the paper ballot 22 using the digital pen 20 just as a typical ballot is marked with an ordinary pen thereby creating an original of the completed paper ballot 22. The paper ballot 22 of FIG. 2A includes a ballot form 28 including election information 32 and a voting area generally indicated by the reference numeral 34. The voting area 34, for example, includes a YES or NO question 36 and a candidate selection area 38. To cast his/her vote, a voter marks the ballot in the appropriate boxes adjacent his/her selections using the digital pen 20. To mark the paper ballot 22, the voter uses a pen stroke that provides a mark on the paper ballot via a writing tip 21. During the pen stroke, the digital pen 20 records the pen stroke and the location of the pen stroke relative to the paper ballot 22 via the dot pattern 30 on the digital paper 26.

The paper ballot 22 including the ballot form 28 imprinted on the digital paper 26 is pre-defined. Therefore the exact coordinates of the ballot form 28 will match an image of the paper ballot previously stored in an appropriate database or memory of the computer 12. Thus, data representing an electronic image of the paper ballot 22 is stored in the memory of the computer 12 and can be reproduced and displayed on the monitor 16 or output via a printer. Each paper ballot 22 can be uniquely identified using either the complete ballot and a unique dot pattern 30 thereon (i.e., the Anoto®-compliant sheet identifier) or a the paper ballot 22 contains a unique identifiable mark. In the former, each unique ballot can be identified using the digital pen 20 and marking anywhere on the paper ballot 22. This method is convenient, however costly as each paper ballot 22 is defined using a unique dot pattern 30. Providing a unique identifier on each paper ballot 22 is discussed further hereinafter.

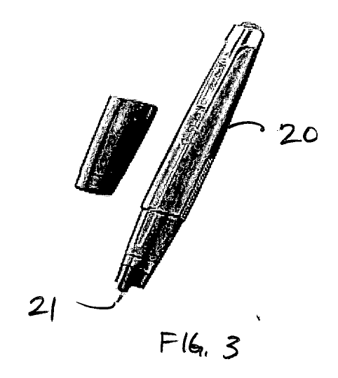

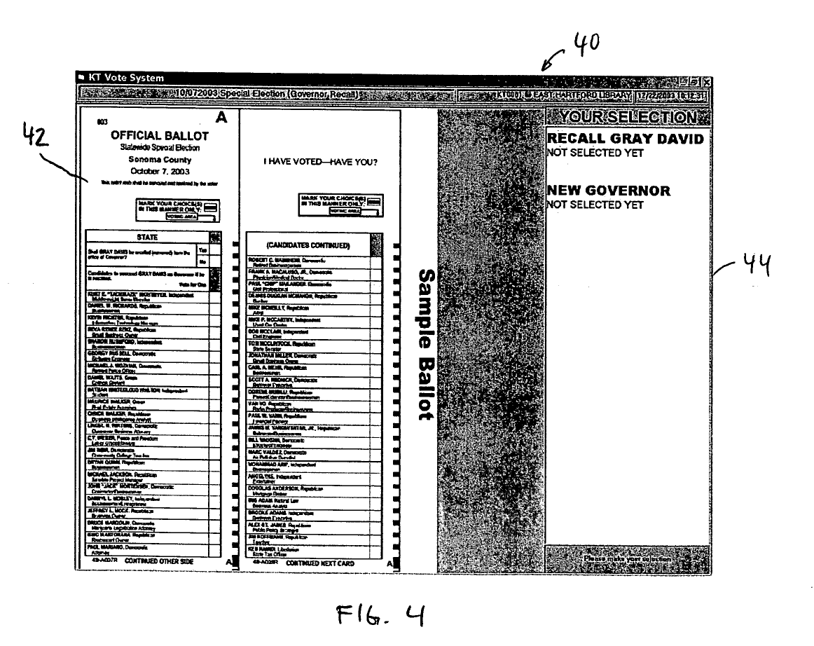

Referring to FIGS. 4-6, in a preferred embodiment of the voting system 10, the digital pen 20 is in communication with the computer 12 including a monitor 16 during a voting process. Accordingly, as a voter completes his/her paper ballot 22 with the digital pen 20, an electronic image of the paper ballot 22 is completed and displayed on the monitor 16 in real time. A voting screen 40, according to the present invention, includes an electronic image 42 of the actual paper ballot 22 to be completed by a voter on the left side of a split screen. The right side of the split screen is a verification screen 44 that provides a summary of the voter's selection(s). In the FIG. 4 embodiment, both the electronic image 42 of the paper ballot 22 and the verification screen 44 indicate that the voter has not yet made any marks on the paper ballot. As the voter completes the paper ballot 22 a voter can use the voting screen 40 to view the electronic image 42 of the paper ballot or the verification screen 44 to confirm his/her vote, as shown in FIG. 5.

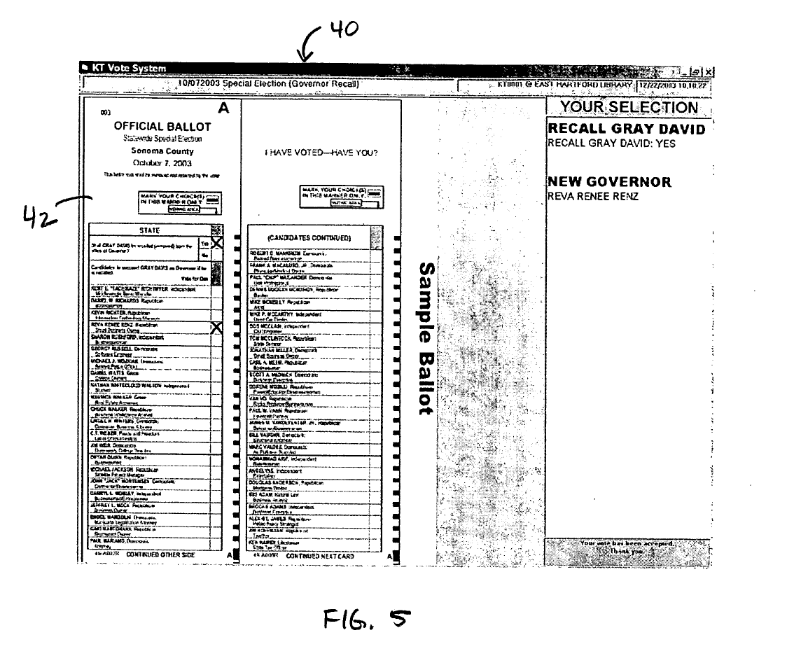

Referring to FIG. 6, the voting screen 40 shows an electronic image 42 of an improperly completed paper ballot 22. Following the marking of the blocks 43 and 45 for two separate candidates—effectively invalidating the vote—the computer 12 detects the voter's error and provides a prompt 46 on the verification screen 44 informing the voter that the vote is rejected and instructing the voter to obtain and complete another paper ballot 22. Accordingly, the data representing the improperly completed ballot 22 can be marked void and discarded or otherwise flagged so that the voided data is not utilized in a tabulation or counting of the votes.

In one embodiment of the voting system 10, once the paper ballot 22 is properly completed, the vote can be accepted by the voter by selecting an “Accept” box 48 as shown on the paper ballot 22 of FIG. 2A. Alternatively, if a voter changes his mind, the voter can void the paper ballot 22 by selecting the “Void” box 49. Once the paper ballot 22 is completed and accepted by a voter, the computer 12 stores data representing the electronic image 40 of the paper ballot, and the voter or appropriate authorities retains the original paper ballot to be stored for later verification of the results of the election if necessary. For example, in the case of a close race, a candidate might request a recount, wherein all or a portion of the original paper ballots 22 would be compared to corresponding electronic copies generated by the computer 12. Alternatively, hard copies of the original paper ballots 22 could be printed out and reviewed and the votes counted and compared to the vote results tabulated by the computer 12.

Additionally, upon acceptance of the uniquely identified paper ballot 22 by a voter, the computer 12 can store the image of the ballot 42 as well as the time and date the vote was cast. The voting system 10 can, upon acceptance of the paper ballot 22 by the voter, add the voter's vote(s) as cast to a running total thereby tallying the votes during the voting process.

Thus, the voting system 10 provides an original paper ballot 22 as well as the capability to reproduce an exact duplicate thereof using the stored pen strokes obtained by the digital pen 20 and an electronic copy of the ballot form 28. Accordingly, the computer 12 can be used to reproduce an electronic image of each paper ballot 22 completed by a voter as well as process data representing the image of each paper ballot 22 as completed. Thus, the computer 12 in accordance with the voting system 10 includes software for processing the data representing the completed paper ballots 22 to tally the votes cast, to monitor the voting process and the results thereof, or for other purpose related to a voting process. Each of the uniquely identified paper ballots 22 once completed by a voter can be retained to verify the results of a voting process if necessary. Therefore, the voting system 10 provides a verifiable voting input system and method of use thereof for voting processes.

Alternatively, the paper ballot 22 can include a unique identifiable mark such as for example, a serial number. The unique mark can be either printed as a printed bar code representing a serial number or other identifier. When a verification or validation process is required for the review of an election or voting process, the voting results tabulated by and/or stored in the memory of the computer 12 of the voting system 10 and retrievable based on the unique identifier can be reproduced in the form of an electronic image of the paper ballot or a hard copy thereof. Thus, each and every paper ballot 22 that was completed, processed and stored during an actual voting process is reproducible for verifying the results of an election or voting process. These reproduced images or hard copies of the paper ballots 22 can be compared with the physically stored original paper ballots 22 filled out in ink by the voter during the voting process using the digital pen 20. Accordingly, using an electronic image or hard copy of the original paper ballot 22, the system and method of the present invention eliminates the possibility for any undetectable alteration of the computer record during the verification process. Additionally, the identifiable one-to-one relationship between the original paper ballots 22 and the reproducible electronic image or hard copy thereof promotes voter confidence in the integrity of the voting system.

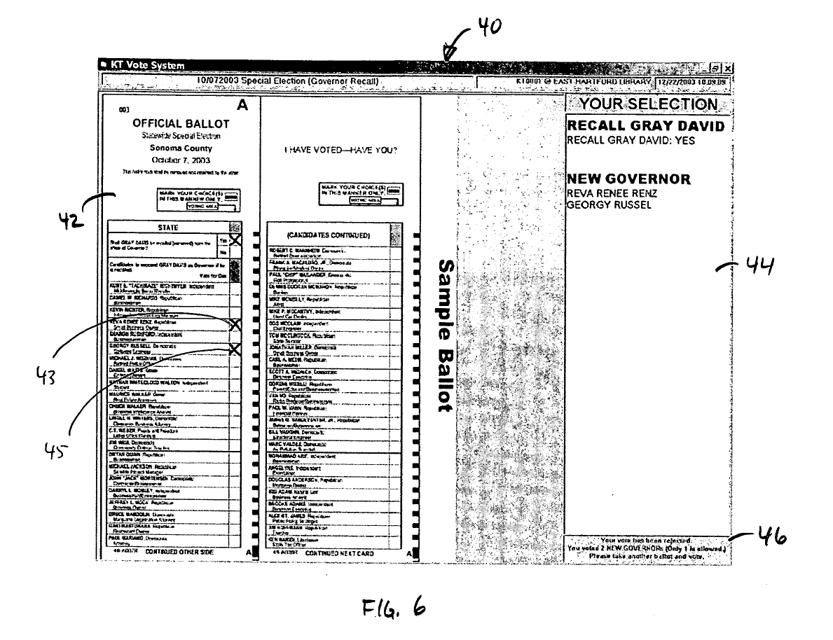

One embodiment of the voting system 10 is illustrated in a flowchart of FIG. 7 and includes a ballot form/pattern database 50 wherein ballot form data corresponding to each paper ballot 22 including the ballot form 28, the dot pattern 30 contained thereon, and other information related to the paper ballot is stored in a memory of the computer 12. Typically, the ballot form data is stored based on a ballot identifier wherein a plurality of ballots are manufactured using the same ballot form 28 and dot pattern 30. Alternatively, if the paper ballot 22 includes a unique identifier, the ballot form data can be stored according to the unique identifier and represents a particular paper ballot having a unique identifier provided thereon.

When a ballot is cast, ballot data including a ballot identifier or unique identifier transmitted from the digital pen 20 is received by the computer 12 at block 52. At block 53, the ballot identifier or unique identifier is used to retrieve the ballot form data from the ballot form/pattern database 50 and confirm or authenticate the ballot identifier. The ballot data is then compared to the dot pattern 30 retrieved from the ballot form/pattern database 50 and processed at blocks 54 and 55 for confirming the location of any voter selections relative to the ballot form 28 and processing the selections which may include tallying the ballot data with respect to a vote count. The ballot data and results thereof are stored and a report generated at block 56. A completed ballot database 58 is provided to store the ballot data retrieved from the digital pen 20 for each paper ballot 22 completed as well as data representing the image of each completed paper ballot and the election results derived therefrom.

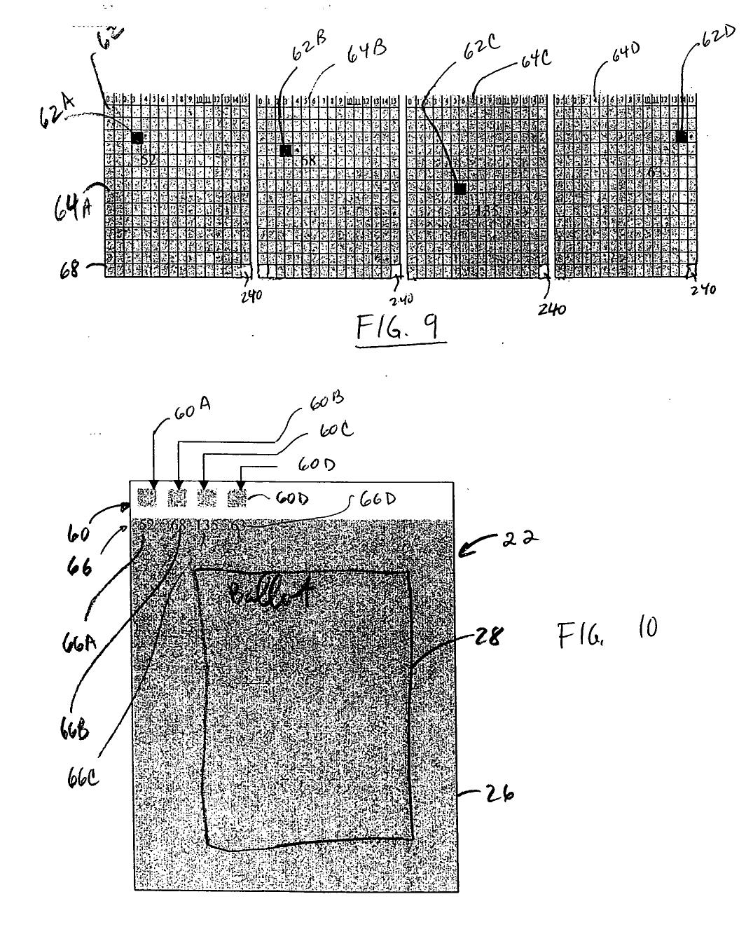

Referring to FIG. 10, in one embodiment of the voting system 10, a unique identifier, generally designated with the reference number 60 is assigned to and reproduced on each paper ballot 22. The unique identifier 60 includes at least one pattern corresponding to an identifiable cell 62 of a master sheet of the digital paper 26 such that the unique identifier 60 is recordable via the digital pen 20. Typically, the unique identifier 60 is recorded during a voting process for identifying the paper ballot 22 and the ballot data received from the digital pen 20 during or after the voting process and associated with the completed paper ballot.

Accordingly, the unique identifier 60 renders each sheet of the digital paper 26 identifiable by the computer 12 via the digital pen 20. As described herein with respect to the ballots and voting system of the present invention, the unique identifier is used to identify each of a plurality of ballots used in a voting process. However, the unique identifier for use with digital paper in accordance with the present invention is not limited in this regard. The unique identifier for use with digital paper disclosed herein can also be used in other applications where it is necessary or desirable to identify a document created using a digital pen and digital paper. For example, a prescription pad formed of digital paper and used by a physician could include a pad of multiple sheets of digital paper each having a unique identifier designated for or assignable to a specific patient according to the present invention that is detectable and recordable via a digital pen. Thus, each written prescription includes a unique identifier that can be recorded and stored along with data retrieved from the digital pen that represents the actual pen strokes the physician created when writing the prescription for the designated patient. Accordingly, the actual prescription information including any drugs prescribed and quantities are recorded and stored with respect to the unique identifier detected and recorded via the digital pen at the time the prescription is written.

Thus, the unique identifier of the present invention that is detectable and recordable via the digital pen provides an efficient and accurate method of identifying and storing documents created on digital paper using a digital pen. Additionally, the unique identifier can be used in the processing, editing or reporting of documents or for other purposes. Other examples of documents wherein the unique identifier for use with digital paper in accordance with the present invention can be used are business forms, employment applications, purchase orders, government forms, tax forms, medical forms and documents, laboratory forms, survey forms and school papers. Accordingly, one skilled in the art will recognize that the voting ballots described herein and the prescription pad mentioned above are just two examples of the various applications of the unique identifier for use with digital paper in accordance with the present invention.

Additionally, one skilled in the art will recognize that the unique identifier for use with digital paper in accordance with the present invention increases the usefulness of a single sheet of digital paper. For example, a single sheet of digital paper 26 having a unique dot pattern 30 can be easily reproduced n times (where n is thousands, hundreds of thousands, millions, or greater) such that each of the sheets of digital paper has a writing surface with the same dot pattern 30. A unique identifier 60 according to the present invention determined using a plurality of identifiable cells of the dot pattern 30 of the same or a different sheet of digital paper 26 can then be imprinted on each of the sheets, providing a unique identifier on each and every one of the n sheets of digital paper. Thus, the unique identifier 60 renders each of the n sheets unique and identifiable via the digital pen 60 and the computer 12. In sum, the unique identifier for use with digital paper in accordance with the present invention can be utilized to identify any number of sheets of digital paper having the same or different dot patterns 30 as will be discussed further hereinafter.

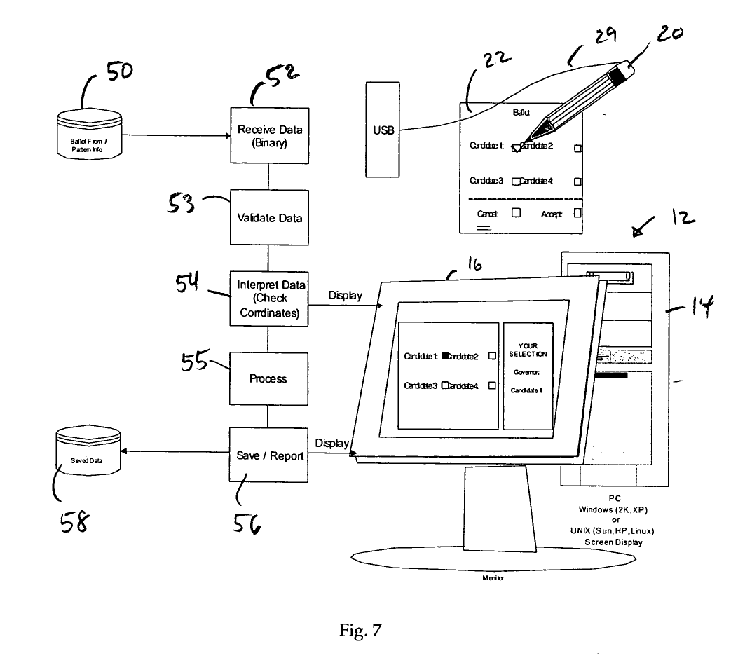

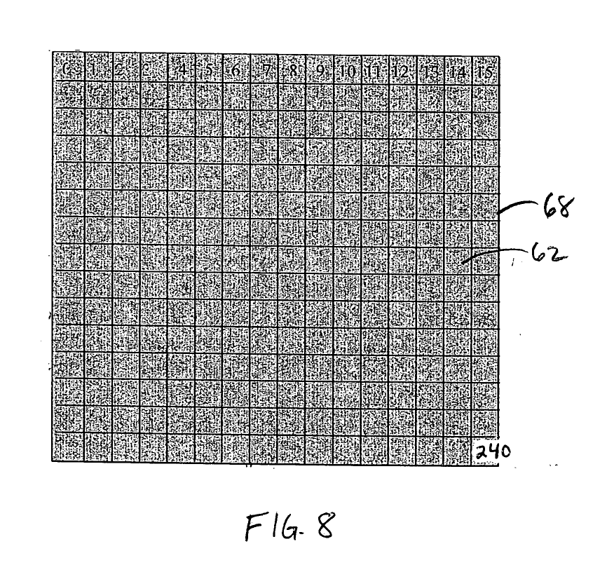

As shown in FIGS. 9 and 10, the unique identifier 60 includes an ordered series of patterns 60A, 60B, 60C, and 60D that each correspond to the pattern contained in an identifiable cell 62 of an ordered series of master sheets 64A, 64B, 64C, and 64D of digital paper 26 used to assign a unique identifier 60 to each of a plurality of paper ballots 22. To establish the unique identifier 60 for each paper ballot 22, a unique identifier number 66 is selected. In the illustrated embodiment, the unique identifier number 66 includes a series of cell numbers 66A, 66B, 66C and 66D that identify a series of cells 62A, 62B, 62C and 62D respectively, one from each of the ordered series of master sheets 64A-64D. In the illustrated embodiment, each of the cells 62A-62D are established using a grid 68 oriented in a pre-determined position relative to the dot pattern 30 of the master sheets 64A-64D of digital paper. As shown if FIGS. 8 and 9, the grid 68 divides the dot pattern 30 of each of the master sheets 64A-64D into 240 cells. Thus, when using four master sheets 64A-64D, the number of possible unique identifier numbers 66 is approximately equal to 240⁴ or 3,317,760,000. More or fewer master sheets 64 can be used depending on the desired number of paper ballots 22 each having a unique identifier 60 associated therewith. Additionally, two or more cells 62 could be identified in each of the master sheets 64, increasing the number of unique identifiers 60 available.

Referring again to FIGS. 9 and 10, the unique identifier number 66 selected for the illustrated ballot 22 is 52.68.135.63. Thus the cell number 66A has a value of 52 and corresponds to the cell 52 of master sheet 64A; cell number 66B has a value of 68 and corresponds to the cell 68 of master sheet 64B; cell number 66C has a value of 135 and corresponds to the cell 135 of master sheet 64C; and cell number 66D has a value of 63 and corresponds to the cell 63 of master sheet 64D. The unique identifier numbers 66 including each of the cell numbers 66A-66D for each paper ballot 22 can be automatically selected in numerical order or randomly selected from the number of cells of the grid 68. For example, if the unique identifier numbers 66 are selected in numerical order, a first paper ballot 22 could have a unique identifier number of 0.0.0.0. Typically, a software application is utilized for determining the unique identifier numbers 66 for the paper ballots 22.

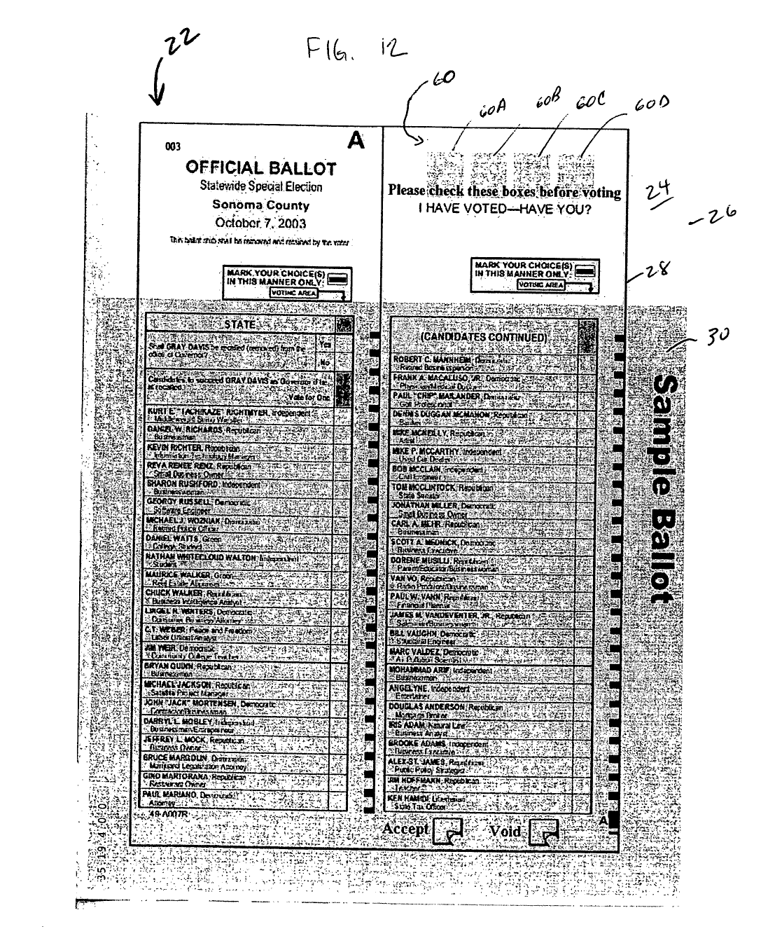

The unique identifier 60 including the ordered series of patterns 60A-60D corresponding to the cells 62A-62D of the master sheets 64A-64D is reproduced on the paper ballot 22 as shown in FIG. 10. Additionally, the unique identifier number 66 including the cell numbers 66A-66D is printed on the paper ballot 22. Alternatively, as shown in FIG. 12, the unique identifier number 66 can be omitted from the paper ballot 22 so that the unique identifier 60 and the associated paper ballot is identifiable only via the digital pen 20 via the computer 12 and a plurality of blank paper ballots 22 all appear to be the same and are non-distinguishable one from the other.

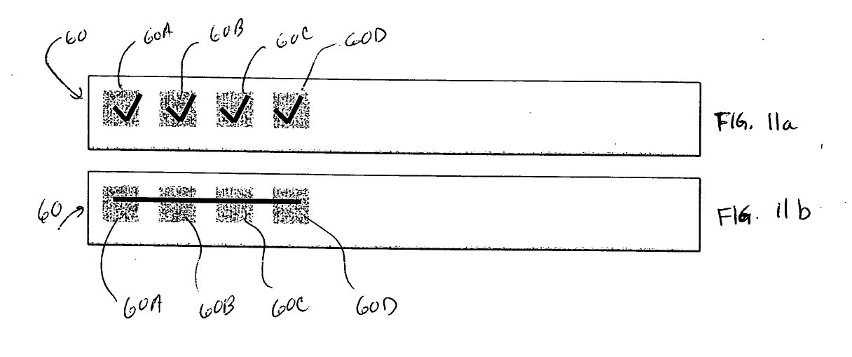

As used, each paper ballot 22 containing a unique identifier 60 can be initialized by a voter using the digital pen 20. As shown in FIGS. 11a and 11b, by marking each of the series of patterns 60A-60D of the unique identifier 60 using the digital pen 20, each of the patterns 60A-60D is recorded by the digital pen 20 and data representing the patterns 60A-60D is transmitted to the computer processor 12. The data representing the patterns 60A-60D is transmitted to the computer 12 during or after a voting process as discussed above and typically following voter acceptance of a completed paper ballot 22. The computer 12 stores the ballot data corresponding to each paper ballot 22 using the unique identifier number 66 derived from the data representing the patterns 60A-60D. Thus, each of the paper ballots 22 include a unique identifier 60 that can be used to identify the paper ballot 22 as well as the stored ballot data that represents the voter selections on the paper ballot.

The unique identifier 60 provided on each of the paper ballots 22 can also be used to monitor a voting process either during or after the completion of the voting process. The paper ballots 22 can be distributed in certain geographic locations, and the unique identifiers 60 can be utilized to sample or review ballot selections by the computer 12 based on geographic or other criteria.

Another feature of the present invention voting system 10 includes a function for ballot management. The paper ballots 22 are printed on digital paper 26, the dot patterns 30 of which are stored in a ballot database 50 (FIG. 7) together with the corresponding ballot form data representing the ballot form 28 and information such as jurisdictions, contest regions and polling locations. The voting system 10 provides an administrative function to manage the assignment of the paper ballots 22 and the printing and distribution thereof. Therefore, every paper ballot 22 can be accounted for—including the ballot form 28 that is printed on each paper ballot 22, the polling location, and where any vote count or tallies will be delivered.

The computer 12 processes the data received from the digital pen 20 including comparing the received data with the ballot form data retrieved from a database 50 and determines the voter selections and votes cast therefrom. The voter selections are stored in the computer 12 along with the electronic image of the paper ballot 22 and the unique identifier 60. Thus, the electronic image 22 and the voter selections for each paper ballot 22 can be retrieved and reviewed using the unique identifier 60 or the unique identifier number 66. Accordingly, a recount of a portion of the paper ballots 22 can be compared with the data stored in the computer 12 related to the recounted paper ballots 22.

The preferred embodiment of the present invention is enabled using the commercially available Anoto® technology. It applies to any future Anoto® or similar technology that produces digital pens and digital paper that can identify and transmit the exact location of the pen strokes to a PC in real time when the digital pen is connected to the PC or other computer system.

Following is a summary of one embodiment of the method steps of a voting process using the voting system 10 of the present invention:

A plurality of paper ballots 22 are pre-printed on digital paper with a ballot form 28 and unique identifiers 60 and distributed to a plurality of polling locations for a given jurisdiction. Ballot form data representing the ballot form 28, the dot pattern associated with the digital paper 26 as well the location of the ballot form with respect to the dot pattern are stored in the memory of the computer 12 along with the unique identifier for each paper ballot. The paper ballots 22 allocated and distributed to each polling location are identified using the unique identifiers 60 and are also stored in the computer 12.

Typically, on the day of voting, after a voter is checked in and verified using a proper identification compared against a voter registration record, a voting administrator picks out a paper ballot 22 from the paper ballots 22 allocated to the particular polling location. The voting administrator then records the associated unique identifier 60 on the selected paper ballot 22 by marking the unique identifier on the paper ballot using a digital pen 20. The paper ballot 22 is thereby initialized by the voting system 10 and ready to be cast. Alternatively, the voter can initialize the paper ballot 22 by marking the unique identifier 60 with the digital pen 20.

The voting administrator hands the initialized paper ballot 22 to the voter.

The voter fills in a voter selection area 34 of the paper ballot 22 by marking the paper ballot 22 using the digital pen 20.

The actual votes are entered into the computer 12 in real time in one of the following ways:

No additional action by the voter if the digital pen 20 is connected to the computer 12 at all times during the voting process;

When the voter places the digital pen 20 onto a pen docking device connected to the computer 12;

When the voter accepts the ballot by checking the box 48 on the paper ballot.

The voter can verify his/her vote by visually checking the marks created by the writing tip 21 of the digital pen 20 on the paper ballot 22.

The voter can also visually verify whether the paper ballot 22 was properly read into the computer by reviewing the electronic image 42 of the paper ballot displayed on the computer monitor 16.

The vote is cast and recorded when the voter accepts the result by marking an accept box 48 on the paper ballot 22 using the digital pen 20. Upon acceptance of the paper ballot 22, the exact date/time is recorded for the paper ballot 22 along with the unique identifier 60 therefor.

The paper ballot 22 is then sealed and stored physically for any future reference which may be necessary or requested.

Through the unique identifier 60, the paper ballot 22 and the corresponding computer record are associated in a one-to-one relationship. The computer record includes data corresponding to electronic representation of the completed paper ballot 22.

The computer 12 processes the data received from the digital pen including comparing the pen strokes and the location thereof with the ballot form data information retrieved from the ballot/form database 50 and determines the voter selections therefrom. The voter selections or votes from each ballot 22 are tabulated and stored and can be added to a running total for each candidate or issue presented on the paper ballot 22.

The foregoing description of embodiments of the invention has been presented for the purpose of illustration and description. It is not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended hereto.

1. A voting system comprising:
a processor having a memory coupled thereto;
a plurality of ballots, each ballot formed of at least one sheet of digital paper having a writing surface and a unique identifier formed thereon, each ballot having a ballot form printed on the writing surface for completion by a voter;
ballot form data corresponding to each ballot and representing the ballot form and the location thereof relative to the writing surface being stored in the memory;
a digital pen for communicating with the processor, the digital pen compatible with the digital paper for recording pen strokes made by the digital pen and the location thereof relative to the writing surface of the digital paper, the digital pen including an ink dispensing tip for marking the writing surface of the digital paper according to the pen strokes;
the unique identifier including at least one pattern corresponding to an identifiable cell of a master sheet of the digital paper such that data representing the unique identifier is recordable via the digital pen;
the digital pen for sensing and recording data representing the unique identifier and the pen strokes formed on each of the ballots used in a voting process;
the processor configured for communicating with the digital pen for retrieving from the digital pen the data representing the unique identifier and the pen strokes formed on each of the paper ballots and including means for storing the unique identifier and the corresponding pen strokes data for each ballot in the memory;
means for processing the data representing the pen strokes for each ballot including comparing the pen strokes data with the corresponding ballot form data for determining the voter selections for each ballot and tabulating the voter selections for each of a plurality of the ballots.

2. The voting system according to claim 1 further comprising a monitor coupled to the processor and configured to display an electronic image of the ballot.

3. The voting system according to claim 2 wherein the processor is configured for generating and displaying on the monitor an electronic image of the ballot in real time during a voting process.

4. A voting system comprising:
a processor having a memory and a monitor coupled thereto;
a plurality of ballots, each ballot formed of at least one sheet of digital paper having a writing surface and a unique identifier formed thereon, each ballot having a ballot form printed on the writing surface for completion by a voter;
ballot form data corresponding to each ballot and representing the ballot form and the location thereof relative to the writing surface being stored in the memory;
a digital pen connectable to the processor, the digital pen compatible with the digital paper for recording pen strokes made by the digital pen and the location thereof relative to the writing surface of the digital paper, the digital pen including an ink dispensing tip for marking the writing surface of the paper according to the pen strokes;
the unique identifier including at least one pattern corresponding to an identifiable cell of a master sheet of the digital paper such that data representing the unique identifier is recordable via the digital pen;
the digital pen for sensing and recording the unique identifier and the pen strokes formed on each of the ballots used in a voting process, means for generating and displaying on the monitor an electronic image of the ballot including the pen strokes created by a voter using the digital pen and retrieved by the processor.

5. The voting system according to claim 4 further comprising means for storing data representing the electronic image of each ballot in accordance with the unique identifier associated with the ballot.

6. The voting system according to claim 4 wherein the digital paper includes a plurality of dots disposed in a pre-defined pattern throughout the writing surface thereof.

7. The voting system according to claim 4 further comprising means for selecting the identifiable cell of a master sheet from a plurality of cells each having a different pattern relative to each other.

8. The voting system according to claim 7 wherein the means for selecting the identifiable cell includes randomly selecting the identifiable cell of the master sheet.

9. The voting system according to claim 4 wherein the unique identifier includes at least one pattern corresponding to an identifiable cell of each of an ordered series of master sheets of the digital paper.

10. The voting system according to claim 7 wherein the unique identifier is associated with a cell number corresponding to the identifiable cell of the master sheet.

11. The voting system according to claim 4 wherein the processor includes means for determining voter selections marked on one of the ballots during a voting process, and means for comparing the pen strokes and the location thereof recorded by the digital pen with the ballot form data corresponding to the ballot.

12. The voting system according to claim 4 wherein each of the ballots includes a ballot form pre-printed on the digital paper including at least one of a unique identifier, election information, and candidate information.

13. The voting system according to claim 4 wherein each ballot defines an accept ballot area on the writing surface where a voter can indicate voter acceptance of a completed ballot by marking the accept ballot area using the digital pen.

14. The voting system according to claim 13 wherein the processor further includes means for recording and storing data representing an image of a completed ballot along with the time and date of the acceptance thereof and the unique identifier associated with the completed ballot.

15. The voting system according to claim 4 wherein the processor further includes means for generating and displaying at least one of an electronic image of the ballot and a verification screen identifying the voter selections on the ballot.

16. A ballot for use with a voting system comprising:
a sheet of digital paper having a writing surface;
a unique identifier formed on the sheet of digital paper;
a ballot form imprinted on the writing surface for completion by a voter using a digital pen that is compatible with the digital paper; and wherein
the unique identifier is detectable and recordable via the digital pen for identifying the ballot.

17. The ballot as disclosed in claim 16 wherein the unique identifier includes at least one pattern corresponding to an identifiable cell of a master sheet of the digital paper.

18. The ballot as disclosed in claim 17 wherein the pattern associated with the unique identifier and recordable via the digital pen is comparable to a pattern associated with the master sheet of digital paper.

19. The ballot as disclosed in claim 16 wherein the unique identifier comprises a series of patterns each corresponding to identifiable cells of a master sheet of digital paper.

20. The ballot as disclosed in claim 16 wherein the unique identifier is imprinted on the sheet of digital paper.
